(19) United States
(12) Patent Application Publication
(10) Pub. No.: US 2008/0276896 A1
(43) Pub. Date: Nov. 13, 2008

(54) Air Control Valve Apparatus For An Internal Combustion Engine

(75) Inventors: Andreas Koster, Essen (DE); Hainrich Dismon, Gangell (DE)

Correspondence Address: GRIFFIN & SZIPL, PC, SUITE PH-1, 2300 NINTH STREET, SOUTH, ARLINGTON, VA, 22204, US

(73) Assignee: PIERBURG GMBH, Neuss, Deutschland D (DE)

(21) Appl. No.: 12/092,043

(22) PCT Filed: Oct. 26, 2006
(86) PCT No.: PCT/EP2006/010319

§ 371 Date: Apr. 29, 2008

(30) Foreign Application Priority Data
Oct. 29, 2005 (DE) 102005051937.7

(51) Int. Cl. F02B 37/16

(52) U.S. Cl. 123/188.4; 123/564

(57) ABSTRACT

Air control valve apparatus (1) for internal combustion engines (2) having a turbocharger (3), wherein the air control valve apparatus (1) is arranged in a bypass channel (4) between the pressure side (5) and the suction side (6) of a boost pressure pump of the turbocharger, having a housing (7) which has an electromagnetic drive unit (8) having a coil (9), a yoke (10) and a core element (11), and a valve unit (12) which can be moved in the housing (7), wherein means (13) are provided which hold the movable valve unit (12) in the closed position in the currentless state, and wherein at least one pressure equalization opening (14) is provided on the movable valve unit (12), wherein the at least one pressure equalization opening (14) can be closed by at least one switching element (15).

This is a National Phase Application in the United States of International Patent Application No. PCT/EP2006/010319 filed Oct. 26, 2006, which claims priority on German Patent Application No. DE 10 2005 051 937, filed Oct. 25, 2005. The entire disclosures of the above patent applications are hereby incorporated by reference.

### FIELD OF THE INVENTION

The invention is directed to an air control valve apparatus for an internal combustion engine comprising a turbocharger characterized in that at least one pressure equalization opening can be closed by at least one switching element.

### BACKGROUND OF THE INVENTION

Such an air control valve apparatus is described in DE 100 20 041 C2, for example. The connection between the pressure side and the suction side of a boost pressure pump of a turbocharger via a bypass line is required for the transition from a high load to the overrun condition of the internal combustion engine, so as to prevent a high delivery by the boost pressure pump against a closed throttle and the pump effect resulting therefrom, as well as a too sharp and sudden drop in the turbo speed with the resulting thermodynamic problems. The air control valve described in DE 100 20 04 C2 has pressure equalization bores which guarantee that, despite the differential pressure between the pressure side and the suction side of the boost pressure pump, a pressure balance is obtained at the valve closure body when in the closed position. This is advantageous in that, even at high pressures in the turbocharger, only a weak closing spring is required for the air control valve because of the pressure equalization. Accordingly, only a relatively weak actuator is required to overcome the weak closing spring, whereby installation space and costs may be reduced.

However, due to the low excess power, such pressure-equalized air control valves are disadvantageous in that a slip-stick effect may occur at the valve closure body, i.e. that the opening point is reproducible to only a limited extent due to the different parameters (contact pressure of the sealing surfaces, temperatures and friction partners). After all, a stronger force of the drive unit is required again to guarantee a safe opening.

Therefore, it is an object of the invention to provide an air control valve apparatus which is both pressure-equalized and avoids a slip-stick effect.

### SUMMARY OF THE INVENTION

This object, in accordance with the present invention, is achieved by an air control valve apparatus (1) for internal combustion engines (2) having a turbocharger (3), the air control valve apparatus (1) being arranged in a bypass channel (4) between the pressure side (5) and the suction side (6) of a pressure boost pump of the turbocharger, having a housing (7) which has an electromagnetic drive unit (8) with a coil (9), a yoke (10) and a core element (11), and valve unit (12) movable in the housing (7), wherein means (13) are provided that hold the movable valve unit (12) in the closed position in the currentless state, and wherein at least one pressure equalization opening (14) is provided at the movable valve unit (12), characterized in that the at least one pressure equalization opening (14) can be closed by at least one switching element (15).

By making at least one pressure equalization opening closable by at least one switching element, it is possible to disable the pressure equalization function during the opening of the air control valve apparatus so that the high pressure on the pressure side can support the opening of the valve. A particularly compact structure of the air control valve apparatus is made possible by the fact that the movable valve unit has a valve rod configured as a first armature element with an adjoining first valve closure body, the first valve closure body comprising a substantially cylindrical central element, a first arm element connected with the housing through a sealing element, and a second arm element communicating with a first valve through a second sealing element. For this reason, it is also advantageous that the movable valve unit is biased by a first spring element that is supported with respect to the core element.

It has proven especially advantageous that the switching element is designed as a valve tappet that is supported so as to be movable in the core element and the valve rod by means of a guide bushing, wherein the end supported at the first valve closure body comprises a second valve closure body, engaging a second valve seat arranged at the guide bushing such that the pressure equalization opening can be closed. Here, the valve tappet may comprise a second armature element that is operatively connected with the core element. With respect to installation space, it is particularly advantageous if the second armature element is situated on the side of the core element averted from the movable valve unit.

To achieve a simple control of the air control valve apparatus, the second armature element has a lesser mass and a shorter distance to the core element than the first armature element, such that the second armature element is actuated faster than the first armature element. Here, the second armature element may comprise a stop resting at a housing part of the coil when energised. The second valve closure body may also be biased by a second spring element supported at the second valve seat.

It has proven particularly advantageous, if the central element comprises a first inward directed edge element and the second valve seat comprises a second outward directed edge element, which fluidically abut each other in the currentless state. In this manner, a pressure equalization between the bypass line and the interior of the air control valve apparatus can take place during the opening movement of the air control valve apparatus.

An embodiment of the invention is illustrated and will be described hereinafter.

### BRIEF DESCRIPTION OF THE DRAWINGS

In the drawings:

FIG. 1 is a schematic illustration of an exemplary supercharged internal combustion engine,

FIG. 2 is a section through the air control valve apparatus of the present invention in the currentless state, and

FIG. 3 is a section through the air control valve apparatus of the present invention in the energized state.

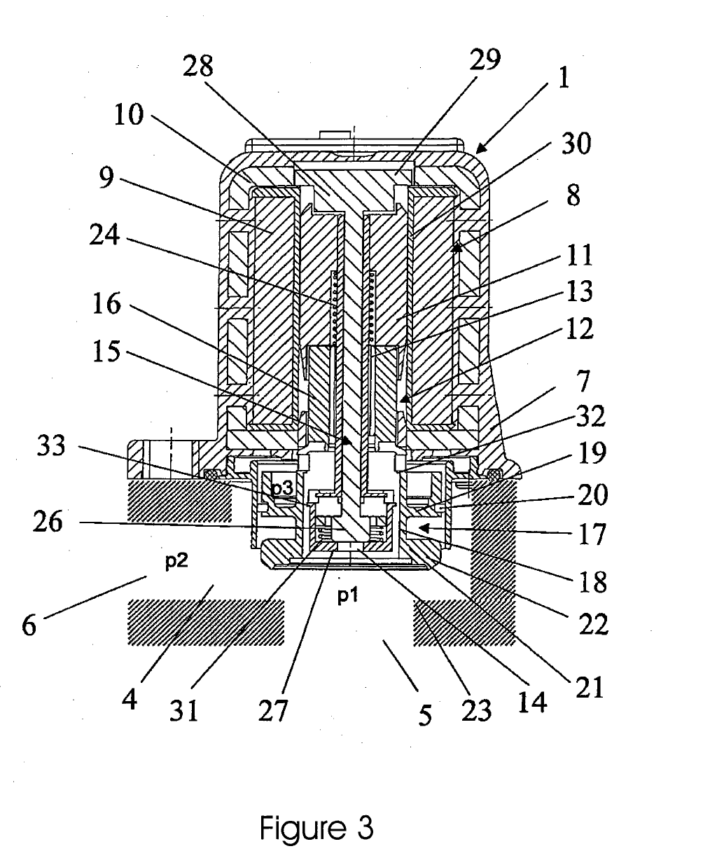

### DETAILED DESCRIPTION OF THE INVENTION

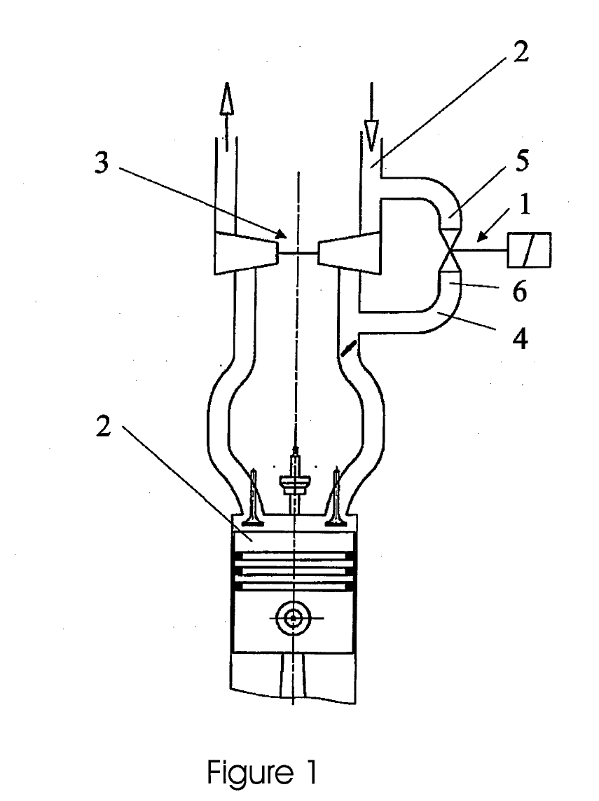

FIG. 1 is a schematic illustration of a supercharged internal combustion engine. An air valve control apparatus 1 for an internal combustion engine 2 comprising a turbocharger 3 is arranged in a bypass channel 4 between the pressure side 5 and the suction side 6 of a pressure boost pump of the turbocharger 3. Ambient air is drawn in through the suction side 6 and compressed by the turbocharger 3 and is then supplied to the internal combustion engine 2. The intake air to be supplied to the internal combustion engine is controlled by a throttle, not illustrated in detail. To prevent a pump effect against the closed throttle, caused by the turbocharger 3 still rotating when the throttle closes fast, for example due to a sudden deceleration, it is known to provide a bypass channel 4. Via this bypass channel 4, compressed intake air can be supplied back into the region of the suction side 6 in front of the turbocharger 3. To control this recirculation of air, an air control valve apparatus 1 is provided in the bypass channel 4.

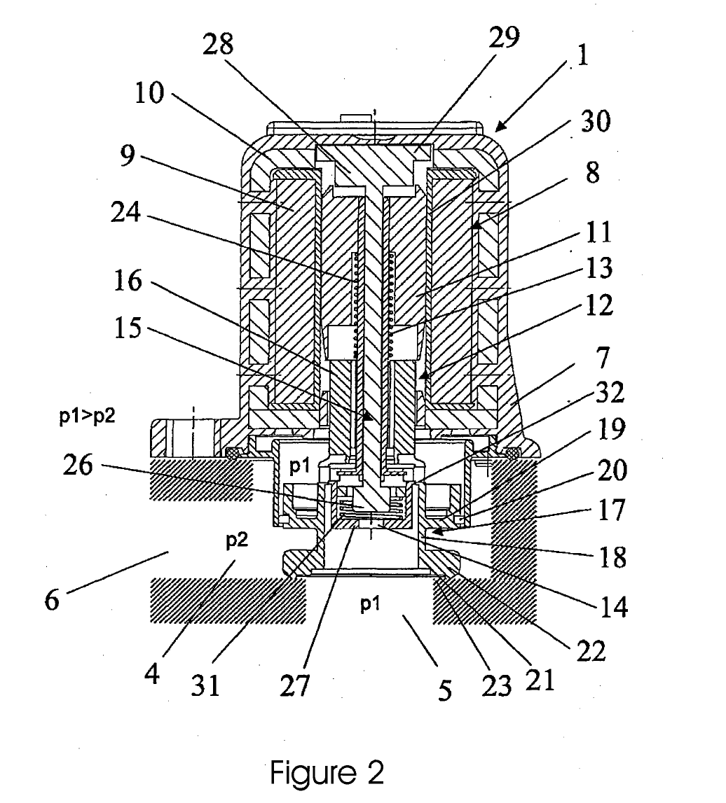

FIG. 2 illustrates the air control valve apparatus 1 of the present invention in the currentless state, i.e. the air control valve apparatus 1 closes the pressure side 5 with a pressure P1 against the suction side 6 having a pressure P2. Here, the air control valve apparatus 1 is configured as follows. A housing 7 which may comprise several parts, includes an electromagnetic drive unit 8 with a coil 9, a yoke 10 and a core element 11. The electromagnetic drive unit 8 is adapted to drive a valve unit 12 movable in the housing 7, a spring 13 being provided in the present case that keeps the movable valve unit 12 in the closed position when in the currentless state. By means of a pressure equalization opening 14, a pressure balance is ensured between the pressure prevailing in the valve unit 12 and the pressure P1 at the pressure side 5. By an appropriate selection of the contact surfaces, it is thus guaranteed in a known manner that the forces acting on the contact surfaces cancel each other out. Thus, the spring force of the spring 13 can be selected to be rather small. It is further illustrated that the movable valve unit 12 comprises a valve rod configured as a first armature element 16 with an adjoining first valve closure body 17. This first valve closure body 17 substantially consists of a cylindrical central element 18, a first arm element 19 connected with the housing 7 by a first sealing element 20 such that the first valve closure body 17 fluidically abuts a wall of the housing 7. Moreover, a second arm element 21 is provided that communicates with a first valve seat 23 via a second sealing element 22 such that, in the currentless state, the pressure side 5 is fluidically separated from the suction side 6.

The cylindrical central element 16 is engaged by a first spring element 24 supported at the core element 11, such that the movable valve unit 12 is biased to the closed position.

In the present embodiment, the switching element 15 is configured as a valve tappet movably supported in a guide bushing 25 in the core element 11 and in the valve rod 16. The valve tappet 15 has a second valve closure body 26 situated at the end of the first valve closure body 17, engaging a second valve seat 27 arranged at the guide bushing 25, such that the pressure equalization opening 14 is closable. In the state illustrated, the air control valve 1 is closed and the pressure equalization opening 14 is opened accordingly.

To be able to move both the movable valve unit 12 and the switching element 15 with a single core element 13, the switching element 15 comprises a second armature element 28 arranged on the side of the core element 11 averted from the movable valve unit 12. In the present embodiment, the second armature element 28 further comprises a stop 29 which, in the currentless state, abuts the housing part 30 of the coil 9.

For the second valve closure body 26 to stay in the open position when in the currentless state, it is biased by a second spring element 31 supported at the second valve seat 27.

FIG. 2 illustrates the air control valve apparatus 1 of the present invention in the open position. To achieve this open position, the coil 9 is energised when in the valve position of FIG. 1, whereby the second armature element 28 is pulled faster to the core element 11 because of its lesser mass and the shorter distance from the core element 11, as compared to the movable valve unit 12, and thereby closes the pressure equalization opening 14 by means of the valve closure body 26. In this manner, the pressure P1 building up on the side 5 can support the opening movement of the air control valve apparatus. Simultaneously, the movable valve unit 12 is attracted by the core element 11. To prevent a counter pressure building up in the air control valve because of the telescoping, the central element 18 has a first inward directed edge element 32 and the second valve seat 27 has a second outward directed edge element 33, which, in the currentless state, abut each other fluidically, while, in the energised state, allowing for a pressure equalization between the inside of the air control valve apparatus and the exterior.

After the throttle has opened again, the energising of the air control valve apparatus is interrupted and the spring elements 26 and 31 return the air control valve apparatus to the initial state as illustrated in FIG. 1.

It should be clear that such an air control valve apparatus is generally also applicable to any other engine and is not restricted to use with supercharged internal combustion engines.

The invention is directed to an air control valve apparatus for an internal combustion engine comprising a turbocharger according to the precharacterizing part of claim 1.

Such an air control valve apparatus is described in DE 100 20 041 C2, for example. The connection between the pressure side and the suction side of a boost pressure pump of a turbocharger via a bypass line is required for the transition from a high load to the overrun condition of the internal combustion engine, so as to prevent a high delivery by the boost pressure pump against a closed throttle and the pump effect resulting therefrom, as well as a too sharp and sudden drop in the turbo speed with the resulting thermodynamic problems. The air control valve described in DE 100 20 04 C2 has pressure equalization bores which guarantee that, despite the differential pressure between the pressure side and the suction side of the boost pressure pump, a pressure balance is obtained at the valve closure body when in the closed position. This is advantageous in that, even at high pressures in the turbocharger, only a weak closing spring is required for the air control valve because of the pressure equalization. Accordingly, only a relatively weak actuator is required to overcome the weak closing spring, whereby installation space and costs may be reduced.

However, due to the low excess power, such pressure-equalized air control valves are disadvantageous in that a slip-stick effect may occur at the valve closure body, i.e. that the opening point is reproducible to only a limited extent due to the different parameters (contact pressure of the sealing surfaces, temperatures and friction partners). After all, a stronger force of the drive unit is required again to guarantee a safe opening.

1. An air control valve apparatus for internal combustion engines having a turbocharger, wherein the air control valve apparatus is arranged in a bypass channel between a pressure side and a suction side of a pressure boost pump of the turbocharger, and the air control valve apparatus comprises:
a housing that has an electromagnetic drive unit with a coil, a yoke and a core element; and
a valve unit movable in the housing, wherein means are provided that hold the movable valve unit in the closed position in a currentless state, and wherein at least one pressure equalization opening is provided at the movable valve unit,
wherein
the at least one pressure equalization opening is closable by at least one switching element.

2. The air control valve apparatus of claim 1, wherein the movable valve unit has a valve rod formed as a first armature element with an adjoining valve closure body, wherein the first valve closure body comprises a substantially cylindrical central element, a first arm element connected to the housing through a first sealing element, and a second arm element communicating with a first valve seat via a second sealing element.

3. The air control valve apparatus of claim 1, wherein the movable valve unit is biased by a first spring element supported at the core element.

4. The air control valve apparatus of claim 2, wherein the switching element is configured as a valve tappet supported moveably by a guide bushing in the core element and in the valve rod, wherein the end situates at the first valve closure body has a second valve closure body engaging a second valve seat provided at the guide bushing so that the pressure equalization opening is closable.

5. The air control valve apparatus of claim 4, wherein the valve tappet comprises a second armature element that is in operative connection with the core element.

6. The air control valve apparatus of claim 5, wherein the second armature element is arranged on the side of the core element averted from the movable valve unit.

7. The air control valve of claim 5, wherein the second armature element has a lesser mass and a shorter distance from the core element than the first armature element so that the second armature element is actuated faster than the first armature element.

8. The air control valve apparatus of claim 4, wherein the second armature element has a stop which, in an energized state, abuts a housing part of the coil.

9. The air control valve apparatus of claim 4, wherein the second valve closure body is biased by a second spring element supported at the second valve seat.

10. The air control valve apparatus of one of claim 4, wherein the central element has a first inward directed edge element and the second valve seat has a second, outward directed edge element, that abut each other in a fluid-tight manner when in the currentless state.

11. The air control valve apparatus of claim 2, wherein the movable valve unit is biased by a first spring element supported at the core element.

12. The air control valve apparatus of claim 1, wherein the switching element is configured as a valve tappet supported moveably by a guide bushing in the core element and in the valve rod, wherein the end situates at the first valve closure body has a second valve closure body engaging a second valve seat provided at the guide bushing so that the pressure equalization opening is closable.

13. The air control valve apparatus of claim 3, wherein the switching element is configured as a valve tappet supported moveably by a guide bushing in the core element and in the valve rod, wherein the end situates at the first valve closure body has a second valve closure body engaging a second valve seat provided at the guide bushing so that the pressure equalization opening is closable.

14. An internal combustion engine comprising:
(a) a turbocharger; and
(b) an air control valve apparatus, wherein the air control valve apparatus is arranged in a bypass channel between a pressure side and a suction side of a pressure boost pump of the turbocharger, and the air control valve apparatus comprises
i. a housing that has an electromagnetic drive unit with a coil, a yoke and a core element; and
ii. a valve unit movable in the housing, wherein means are provided that hold the movable valve unit in the closed position in a currentless state, and wherein at least one pressure equalization opening is provided at the movable valve unit,
wherein the at least one pressure equalization opening is closable by at least one switching element.
